(19) United States
(12) Patent Application Publication
(10) Pub. No.: US 2026/0369267 A1
(43) Pub. Date: Nov. 19, 2026

(54) SYSTEMS AND METHODS FOR FORWARD-BACKWARD LOOKUP FOR SIGNAL PROCESSING

(71) Applicant: Capital One Services, LLC, McLean, VA (US)

(72) Inventors: Kushal Chawla, Jersey City, NJ (US); Alfy Samuel, White Plains, NY (US); Anoop Kumar, Fountain Valley, CA (US); Daben Liu, Belmont, MA (US)

(73) Assignee: Capital One Services, LLC, McLean, VA (US)

(21) Appl. No.: 19/212,597

(22) Filed: May 19, 2025

(51) Int. Cl. G10L 15/18; G10L 15/22

(52) U.S. Cl. CPC G10L 15/1815; G10L 15/22

(57) ABSTRACT

Systems and methods for forward-backward lookup for generating outputs. For example, the system may receive a user input for generating a contextual response. The system may determine, using a first model, a refined context for generating the contextual response by: determining a first context state; reducing a size of the first context state to determine a second context state; and comparing an overlap between the first context state and the second context state to determine a third context state. The system may input the user input and the third context state into a second model to determine the contextual response.

### BACKGROUND

Signal processing, which may include speech processing, text processing used by a conversational artificial intelligence assistant is difficult due to the complex and variable nature of human speech and/or other signals, which introduces numerous challenges for computational systems. One major difficulty lies in the variability of speech patterns across different speakers, including differences in accent, pitch, speaking speed, intonation, and pronunciation. These variations can significantly affect the accuracy of speech recognition systems. Additionally, speech often contains informal language, interruptions, filler words, and background noise, all of which complicate the task of extracting clean and meaningful signals. Unlike written text, spoken language lacks clear boundaries between words, making segmentation a non-trivial task. Environmental factors such as echo, overlapping voices, or poor microphone quality can further degrade performance. Moreover, understanding speech involves not only transcribing words but also interpreting context, emotion, and intent, which requires models to integrate linguistic, acoustic, and sometimes even visual information. These factors combined make speech processing a highly challenging domain in artificial intelligence and signal processing.

Retrieval-Augmented Generation (RAG) systems can assist with speech processing by enhancing the understanding and generation of speech-derived content through the integration of external knowledge. When speech is transcribed into text, RAG can be applied to enrich that textual representation by retrieving relevant information from large knowledge bases or document collections. This is especially valuable in scenarios where the spoken content is ambiguous, incomplete, or lacks context—for example, in customer service calls, educational lectures, or medical dictations. RAG systems can retrieve supporting facts, definitions, or follow-up questions that help clarify or expand on what was said, allowing a downstream language model to generate more informed, accurate, and coherent outputs. Additionally, RAG can aid in real-time applications like voice assistants by quickly retrieving relevant documents or prior conversation history to personalize responses. By grounding speech-based inputs in factual and contextual data, RAG systems help reduce hallucinations, improve comprehension, and support more intelligent interactions in speech-driven interfaces.

However, RAG systems are not used for speech processing because of the additional complexity and resource demands involved in bridging the gap between raw audio and effective retrieval-based augmentation. Speech data must first be accurately transcribed into text through automatic speech recognition (ASR), a process that is itself prone to errors, especially in noisy environments or with speakers who have strong accents or atypical speech patterns. These transcription inaccuracies can significantly degrade the performance of the retrieval component, as queries derived from imperfect text may fail to match relevant context or documents. Additionally, speech often lacks the clear structure and punctuation of written language, making it harder to formulate precise queries for retrieval. There are also latency and computational challenges when integrating RAG into real-time speech systems, as it involves both retrieval and generation steps, each of which adds delay.

### SUMMARY

Systems and methods are described herein for novel uses and/or improvements to RAG systems that may mitigate the technical challenges discussed above. In particular, systems and methods mitigate these technical challenges through the use of forward and backward lookup when determining contexts for processing inputs to generate responses. As stated above, RAG systems introduce additional complexity and resource demands because they require careful orchestration between retrieval and generation components, each with their own challenges. A central issue is balancing the quality and quantity of the retrieved context: if the system retrieves too broadly to ensure relevant information is included, it often also pulls in irrelevant content that can confuse the language model, dilute important signals, and degrade the quality of the generated output. Conversely, if the retrieval process is too strict or narrowly focused, it risks excluding critical context needed to answer the query accurately, leading to incomplete or hallucinated responses. This tradeoff creates a delicate optimization problem. Moreover, RAG workflows must manage indexing, semantic search, and retrieval latency, all of which add infrastructure and computational overhead compared to pure generation models. The system also needs mechanisms to rank, filter, and compress retrieved documents, especially when operating within the model's context length limit. These added layers of logic and processing introduce not only engineering complexity but also additional points of failure, making RAG systems harder to build, tune, and deploy effectively at scale.

Conventional approaches to RAG are “backward-looking” because they rely solely on the input query to retrieve relevant information from a knowledge base or document corpus. This means the system analyzes the wording, semantics, and structure of the query and then searches for context chunks that overlap or match it. This approach is practical and grounded because the query is the only known variable at the time of retrieval—there is no knowledge yet of what the model will reason through or generate as an answer. In contrast, a “forward-looking” approach, which attempts to anticipate the content of the final answer or reasoning path before it is generated, is inherently speculative and prone to inaccuracies. Without access to the model's internal reasoning or final output, forward-looking retrieval can misidentify which pieces of context are most relevant, especially for complex or underspecified queries. Therefore, conventional RAG systems default to backward-looking retrieval because it is more deterministic and reliable, ensuring that retrieval is anchored in known input rather than uncertain projections of what the output might require.

In contrast to this conventional approach, the systems and methods use a forward-backward approach. For example, a forward-backward approach can overcome many of the technical problems associated with conventional RAG systems by strategically combining the strengths of both forward and backward retrieval processes. In this setup, the system begins with a forward lookup, using a lightweight language model to generate potential reasoning paths or answer candidates based on the query and an initial context sample. This forward step is not intended to be fully accurate or final but serves a simpler purpose: to highlight terms, concepts, or phrases that are likely to appear in a useful answer (e.g., to reduce the size of a context state). Because this step only needs to identify rough thematic relevance rather than generate a perfect response, the risk of error is low, and the computational burden remains manageable. The system then performs a backward lookup, using these forward-generated signals to refine its retrieval by aligning them with the input query to generate a contextual response. This dual strategy helps the system zero in on the most contextually relevant chunks while avoiding common pitfalls of both overly narrow and overly broad retrieval. By allowing the forward results to inform and guide the backward search, the system enhances precision without sacrificing recall, ultimately delivering more focused and effective context to the language model for final generation.

In some aspects, systems and methods for forward-backward lookup for generating outputs are described. For example, the system may receive a user input for generating a contextual response. The system may determine, using a first model, a refined context for generating the contextual response by: determining a first context state; reducing a size of the first context state to determine a second context state; and comparing an overlap between the first context state and the second context state to determine a third context state. The system may input the user input and the third context state into a second model to determine the contextual response. The system may generate for display, on a user interface, the contextual response.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a user interface, in accordance with one or more embodiments.

FIG. 2 shows an illustrative diagram for illustrating forward-backward look up, in accordance with one or more embodiments.

FIG. 3 shows illustrative components for a system used to generate outputs, in accordance with one or more embodiments.

FIG. 4 shows a flowchart of the steps involved in forward-backward lookup for generating outputs, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

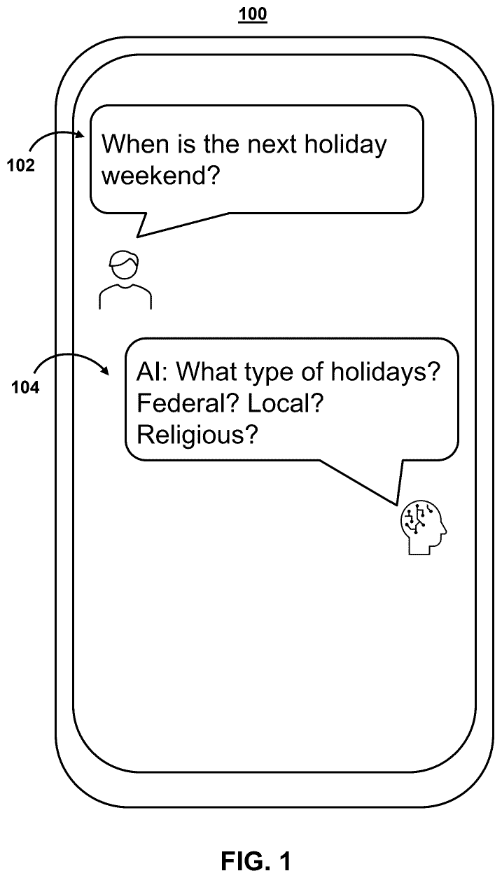

FIG. 1 shows an illustrative diagram for a user interface, in accordance with one or more embodiments. For example, as shown in FIG. 1, user interface 100 may use forward-backward lookup to generate contextual response 104 in response receiving user input 102. As described herein, a user interface may be the point of interaction between a human user and a digital system, application, or device, designed to facilitate communication and control. It encompasses all the visual, auditory, and tactile elements that allow users to input commands and receive feedback, including buttons, menus, text fields, icons, voice prompts, and display screens. The primary goal of a user interface is to make complex systems intuitive and accessible, enabling users to navigate functions, perform tasks, and interpret outputs with ease.

A system may use forward-backward lookup to generate a contextual response 104 in response to user input 102 for text modality within a question answering system or conversational AI assistant by leveraging bidirectional context to enhance semantic understanding and response accuracy. When user input 102 is received—such as a natural language query or command—the system first processes it using a forward pass, which interprets the input sequentially from beginning to end. This forward processing helps establish the initial intent, topic, and syntactic structure of the query. Simultaneously, or subsequently, the system performs a backward lookup, analyzing the input in reverse—typically from the end to the beginning—to capture dependencies or contextual clues that may appear later in the input but are critical for correct interpretation (e.g., qualifiers, negations, or final disambiguating clauses).

This bidirectional analysis allows the system to construct a more complete representation of the user's intent, effectively modeling both past and future context within the sequence. The forward-backward lookup can also be applied to external knowledge bases, retrieval systems, or memory stores, enabling the system to look up relevant facts or prior dialogue history in both directions. For example, it may forward-search relevant answers based on current query keywords, and then backward-check previously stored responses or metadata to refine or filter the result.

The contextual response 104 is then generated by combining these insights, ensuring that the response is not only semantically aligned with the current input but also informed by both immediate and broader conversational context. This approach enhances coherence, accuracy, and contextual sensitivity in dynamic, multi-turn dialogues, making the AI assistant more effective in understanding nuanced queries and maintaining natural, informative conversations.

As described herein, a user input may be any action or data provided by a user to a system through a user interface, serving as a command, query, or piece of information that the system processes to perform a task or generate a response. User inputs come in various types, each corresponding to the form of interaction supported by the interface. One type is text input, where users type queries or commands into a search box or text field—for example, entering a question into a chatbot. Touch input involves interactions such as tapping, swiping, or dragging on a touchscreen, like selecting an app or scrolling through a webpage. Voice input allows users to speak commands or questions, which the system processes through speech recognition, such as asking a virtual assistant for the weather. Mouse input includes clicking, right-clicking, or dragging items using a pointer on a desktop interface. Gesture input, used in systems with motion sensors or cameras, involves body movements or hand signals—for example, swiping in the air to turn a page in an AR/VR environment. Biometric input includes fingerprint scans or facial recognition used for authentication. Each type of input plays a crucial role in enabling users to communicate with digital systems in diverse and context-appropriate ways.

As described herein, a response may be the output or feedback generated by a system in reaction to a user input, completing the interaction cycle within a user interface. It provides users with the result of their command, query, or action, and can take various forms depending on the nature of the system and the context of the interaction. One common type is a visual response, such as displaying search results after a user types a query or showing an alert message when a form submission fails. Another is an auditory response, where the system uses sound or spoken feedback—for instance, a voice assistant replying to a question or a notification chime indicating a message has been received. Haptic responses involve tactile feedback, such as a smartphone vibrating in response to a touch input or a failed authentication. There are also multimodal responses, which combine visual, auditory, and tactile cues, like a smart speaker with a screen that both speaks and displays the answer to a user's request. Examples include a chatbot generating a text answer to a user query, an ATM displaying transaction details after a PIN is entered, or a navigation app recalculating and visually updating a route after a turn is missed. Each type of response is designed to provide clear, timely, and relevant feedback, helping users understand system behavior and guiding them toward their next action.

In some embodiments, the response (e.g., response 104) may be a contextual response. As described herein, a contextual response is a type of system-generated output that is tailored to the specific circumstances, background information, or environment surrounding a user's input. Unlike generic responses, a contextual response takes into account additional factors such as the user's previous interactions, preferences, location, or supplemental data to provide a more relevant and personalized reply. For example, if a user asks a virtual assistant “What's the weather like?”, a contextual response would include the weather forecast for the user's current location without needing them to specify it. Similarly, in a customer service chatbot, if the user has already mentioned an issue with a recent order, a contextual response would acknowledge that issue and provide targeted assistance rather than asking the user to repeat the information. Contextual responses rely on the system's ability to maintain memory, integrate external data sources, or process metadata, resulting in a more natural and efficient user experience. This type of response is especially valuable in systems powered by artificial intelligence, where understanding nuance and adapting to situational cues is critical for generating helpful and human-like interactions.

For example, user interface 100, as shown in FIG. 1, may use a forward-backward lookup mechanism to generate contextual response 104 after receiving user input 102. When the user asks, “When is the next holiday weekend?”, the system may initially perform a forward lookup by passing the question through a lightweight language model to generate possible interpretations or anticipated answer forms—such as “Memorial Day,” “local bank holiday,” or “religious observance.” These forward-generated elements help the system infer what kinds of clarifying details or categories could influence the answer. This reasoning is used to identify potential dimensions of the query—such as types of holidays (federal, local, or religious)—that are necessary to narrow down relevant context.

As described herein, a lightweight model may be a machine learning model that is designed to be computationally efficient, requiring fewer resources in terms of memory, processing power, and latency compared to larger, more complex models. These models are typically optimized for tasks where speed, low power consumption, or deployment on resource-constrained devices—such as mobile phones, edge devices, or real-time systems—is critical. Despite their smaller size, lightweight models aim to maintain acceptable levels of accuracy and performance by using techniques such as model pruning, quantization, knowledge distillation, or architectural simplifications. In natural language processing, for instance, lightweight models might be distilled versions of larger transformers that retain core capabilities while reducing the number of parameters. These models are particularly valuable for preliminary or auxiliary tasks, such as in forward-lookups in RAG systems, where they can quickly generate candidate outputs or reasonings without incurring the high computational cost of running a large-scale model.

Using the output from the forward lookup, the system then performs a backward lookup, examining the original query in conjunction with the anticipated categories to determine which clarifying question would most effectively guide the conversation. This backward step helps confirm that the ambiguity in the user's query is due to missing contextual parameters, and enables the system to respond intelligently by prompting the user for more precise information. The result is contextual response 104, in which the AI asks, “What type of holidays? Federal? Local? Religious?”, thereby efficiently narrowing the information space. This forward-backward process allows the system to provide a more interactive, intelligent, and context-aware response than a purely backward-looking or one-shot generation approach.

For example, a system may implement this method for generating a contextual response from speech input by performing a multi-stage process that combines both forward and backward context analysis. The process begins when the system receives a user input in the form of speech signals, such as a spoken question or command. The system uses a speech recognition module to convert the raw audio into a transcribed text representation, which becomes the basis for further semantic processing.

Next, the system employs a first speech signal processing model to conduct a forward context analysis to refine the input context. It first determines a first context state, which consists of a large corpus of candidate context chunks—such as previous conversation turns, domain-specific documents, or knowledge base entries—relevant to the speech input. Because this initial state may contain redundant or irrelevant data, the system reduces the size of this corpus to determine a second context state, a smaller, more manageable set of context chunks selected for their closer alignment with likely answer patterns, key terms, or semantic themes predicted from the forward-looking analysis.

Then, the system performs a comparative overlap between the first and second context states to evaluate which context chunks are consistently deemed relevant in both. The output of this comparison is a third context state, which represents a more refined set of chunks forming a third corpus of context that is both concise and semantically robust.

With this third context state determined, the system shifts to backward context analysis using a second speech signal processing model. This model takes as input both the original user query (now in transcribed text form) and the third context state, and processes them jointly to generate a contextual response that is grounded in both the user's intent and the most relevant, filtered knowledge. This model may be a large instruction-tuned LLM adapted for dialogue or task-specific response generation.

Finally, the system generates the contextual response for display on the user interface, which could be in the form of text, synthesized speech, or a combination of modalities. This layered forward-backward approach ensures that the generated response is not only accurate and context-aware, but also efficiently computed by focusing on only the most relevant information, even in the presence of ambiguous or open-ended speech input.

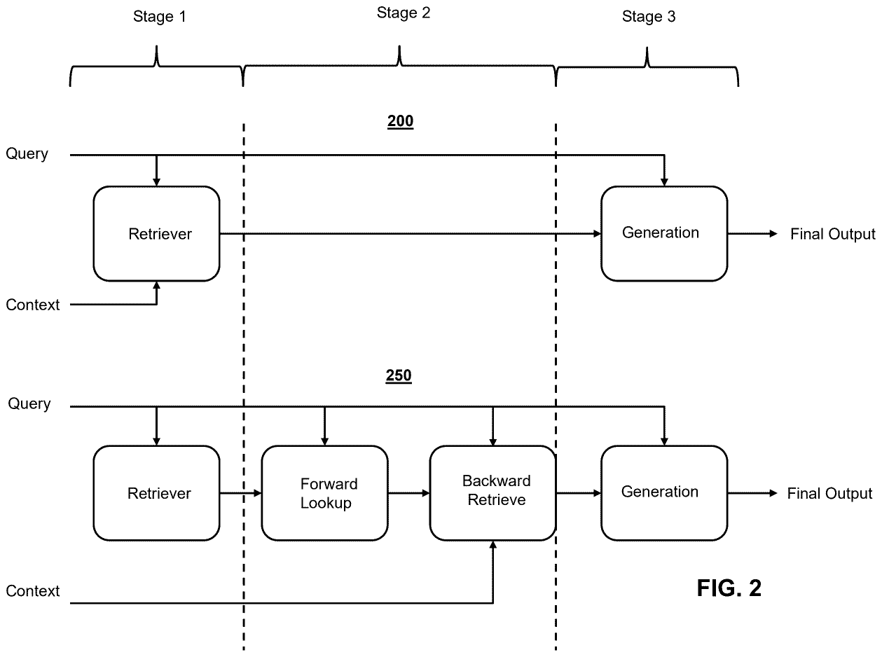

FIG. 2 shows an illustrative diagram for illustrating forward-backward look up, in accordance with one or more embodiments. For example, FIG. 2 contrasts a RAG approach (e.g., approach 200) with a forward-backward RAG framework (e.g., approach 250) for generating accurate and contextually relevant answers to user queries.

FIG. 2 illustrates a three stage process for the forward-backward lookup. For example, t first stage (e.g., Recall-focused Retrieval) begins with a retriever selecting a broad set of candidate context chunks from the original context set C. This retrieval step may prioritize recall, meaning it selects a larger collection of chunks that are likely to include the relevant ones, even at the cost of introducing some irrelevant data. This reduced context set is referred to as C₁. The purpose of this stage is not to generate an answer but to narrow down the full context C to a manageable size for the next stage.

The second stage (e.g., Precision-focused Retrieval) refines this selection using a forward-backward scoring method. For example, a lightweight instruction-tuned language model L is used to generate multiple reasoning and answer pairs [Rₖ, Aₖ] based on the query Q and the context C₁. The system then computes the importance score for each chunk Cᵢ∈C based on its relevance to both the original query (backward-looking) and the generated reasoning-answer samples (forward-looking). The final score is a weighted combination:

S_{FB}(Cᵢ; Q, C)=ηB·S(Cᵢ; Q)+ηF·maxₖS(Cᵢ; [Rₖ, Aₖ]), where ηB and ηF control the balance between backward and forward components. The highest-scoring chunks are selected to form C₂, a smaller, more precise context used in the final generation.

The third and final stage, Generation, feeds the query Q along with the refined context C₂ into a more powerful language model G to produce the final answer. This separation of concerns allows the system to use a lighter model for exploratory reasoning and context ranking, while relying on a more capable model for the final response.

Importantly, the system is not constrained by the quality of outputs from the lightweight model L, because those outputs are only used to inform chunk scoring—not as final answers. Similarly, the final generation step benefits from an improved context due to the precision-focused retrieval step, regardless of how noisy the initial recall step may have been. This three-stage architecture enables the system to outperform traditional RAG methods, especially in cases where the input query is vague or underspecified

For example, as shown in FIG. 2, approach 200 includes only two stages. A first, retrieval stage and a second, generation stage. At the first stage, a retriever selects relevant context chunks from a larger body of information based solely on overlap with the input query. This is a “backward-looking” process, as it evaluates the context purely by matching it with what the user has already asked. At the generation stage, the retrieved context is passed along with the query to a language model, which generates the final output. While effective for direct queries, this approach can fail with vague or underspecified inputs, where important context may not be retrieved if it is not closely aligned with the query text.

In contrast, approach 250 introduces a three-stage pipeline that enhances context selection by using both query-driven (backward) and answer-driven (forward) retrieval. For example, at stage 1 an initial retrieval is performed by a retriever first narrowing down the context to a manageable subset (C₁), ensuring recall but not necessarily precision. Next, at stage two a forward-backward lookup is performed. For example, a lightweight language model may perform a forward lookup, generating possible reasoning paths and answer candidates based on the initial context. These forward samples are used by the system to identify context chunks that overlap with the generated content. Simultaneously, a backward lookup checks which context chunks overlap with the original query. Both forward and backward importance scores are combined (weighted by parameters ηF and ηB) to compute a refined ranking of chunks. This leads to a more precise context subset (C₂) that is highly likely to support accurate generation. Finally, a more powerful LLM uses the query and the precisely selected context chunks (C₂) to produce the final output. Because irrelevant or noisy chunks are minimized, and reasoning-supporting ones are elevated, the generated response is more accurate and grounded.

Notably, this hybrid approach addresses key limitations of traditional RAG systems—such as retrieving irrelevant content or missing critical information due to vague queries—by leveraging forward reasoning to inform backward retrieval. It improves the ranking of context chunks, reduces the input length needed, and ultimately helps the LLM focus on the most useful information. Furthermore, by using a lightweight model for forward lookup and a larger one for generation, it strikes a balance between computational efficiency and performance.

For example, the method begins with a query Q, a context composed of multiple chunks C={C1, C2, . . . , Cn}, and a retriever scoring function S(cᵢ;q) that assigns importance scores to each context chunk cᵢ based on its similarity to the input query Q. In the system, a retriever uses only the query to compute relevance, but this can be ineffective when the query is vague or underspecified. To address this limitation, the system introduces an enhanced scoring function S_{FB}(cᵢ; Q, C) that leverages both the original query and potential answers to better estimate chunk relevance.

In some embodiments, the system may have access to a perfect oracle language model L* capable of generating the best possible response A* to score chunks based on their overlap with that output using S_{FB}(Cᵢ; Q, C)=S(Cᵢ; A*). However, since answers can be short or ambiguous, this is extended to include the ideal reasoning R* leading to the answer, resulting in the formulation S_{FB}(Cᵢ; Q, C)=S(Cᵢ; [R*, A*]). The assumption is that the chunk most relevant to the reasoning and answer, Cᵢ* will have the highest score under this combined representation.

In practice, the system may not access L*, so it approximates this behavior using a real, instruction-tuned language model L. This model generates reasoning and answer pairs [R, A], which are then used to score the context chunks as S_{FB}(Cᵢ; Q, C)=S(Cᵢ; [R, A]). To handle uncertainty and variability in the model's outputs, the system generates K samples and computes the maximum score across them: S_{FB}(Cᵢ; Q, C)=max_{k, k=1}S(Cᵢ; [R, A]) This ensures that any chunk referenced meaningfully in at least one sample receives a high score, even if it is not consistently referenced across all generations.

To further enhance robustness, especially when the forward-looking component may be noisy or misleading, the system incorporates a backward-looking component based on the original query. The final importance score is a weighted combination of the backward and forward scores: S_{FB}(Cᵢ; Q, C)=ηB·S(Cᵢ; Q)+ηF·max_{k, k=1}S(Cᵢ; [R, A]), where ηB and ηF are tunable weights. This combination allows the system to dynamically balance reliance on the input query versus model-predicted answers and reasoning, enabling it to more effectively identify the most relevant context chunks. The result is a more precise and adaptive retrieval process that improves the quality of context passed to the final language model for answer generation

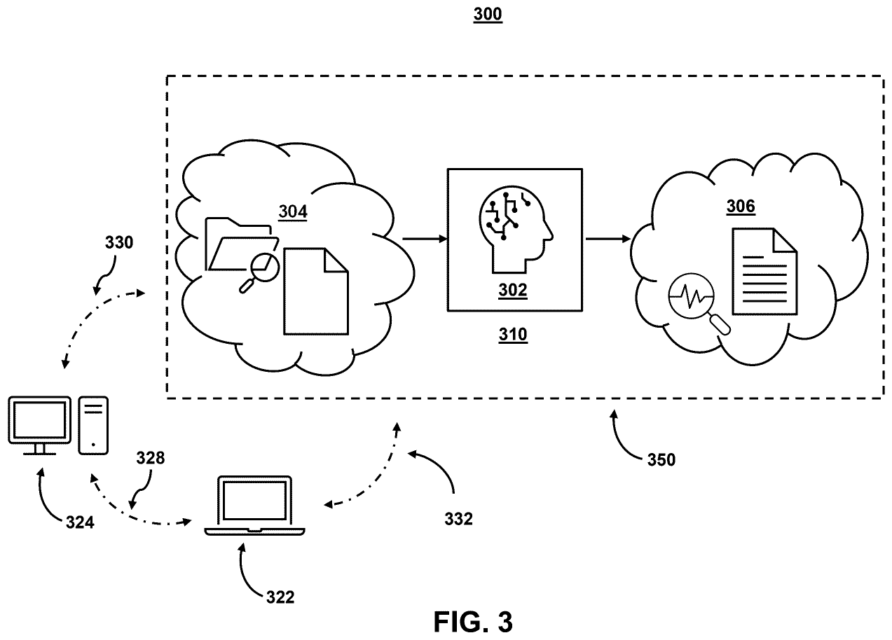

FIG. 3 shows illustrative components for a system used to generate outputs, in accordance with one or more embodiments. For example, FIG. 3 may show illustrative components for forward-backward lookup for speech signal processing. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The output of the model (e.g., model 302) may be used to determine a response.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

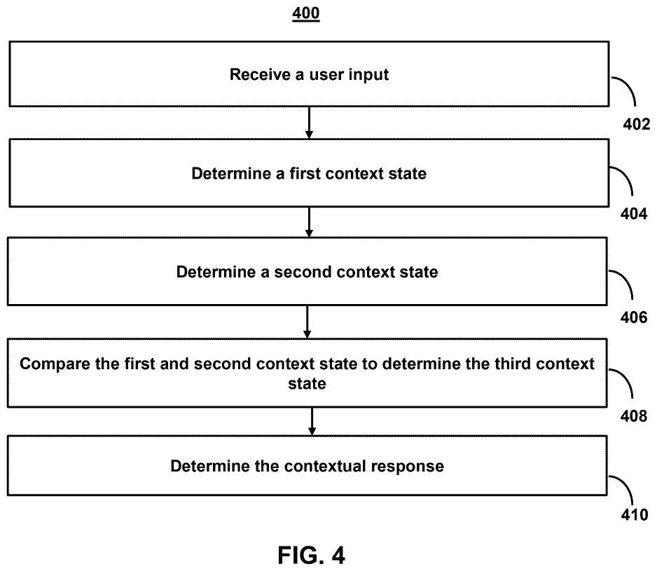

FIG. 4 shows a flowchart of the steps involved in forward-backward lookup for generating outputs, in accordance with one or more embodiments. For example, the system may use process 400 (e.g., as implemented on one or more system components described above) in order to use forward-backward lookup for speech signal processing.

At step 402, process 400 (e.g., using one or more components described above) receives a user input. For example, the system may receive a user input for generating a contextual response. The system may receive a user input for generating a contextual response by capturing the input through an interface capable of handling the intended modality, such as a microphone for speech or a text box for written queries. In the case of speech input, the system begins by detecting and recording the audio signal, which is then passed to an automatic speech recognition (ASR) component that transcribes the spoken language into text. This transcribed text serves as the formal representation of the user input and is used as the basis for downstream processing. If the input is typed or otherwise text-based, it can be directly collected and structured by the interface. Regardless of the format, the system may also simultaneously extract additional metadata or contextual signals—such as the time of input, user identity, prior interactions, or environmental cues—to enhance contextual understanding. This user input is then forwarded to the core processing engine, which interprets the query and initiates further steps such as context retrieval, reasoning, and response generation. By effectively capturing and structuring the user input, the system ensures that it has a reliable foundation for producing a relevant and personalized contextual response.

At step 404, process 400 (e.g., using one or more components described above) determines a first context state. For example, the system may determine, using a first model, a refined context for generating the contextual response. The system may begin by determining a first context state. For example, the system may determine, using a first model, a refined context for generating the contextual response by initiating a multi-step context filtering process. It begins by establishing a first context state, which includes a broad set of candidate context chunks—such as text passages, conversation history, or knowledge base entries—that may contain information relevant to the user input. These chunks are typically selected using lightweight retrieval methods based on the initial transcription or interpretation of the user input. The system then uses a first model, such as a lightweight language model or semantic ranker, to analyze this first context state and evaluate the relevance of each chunk based on a forward-looking analysis. This involves predicting which context elements are likely to contribute to plausible answers or reasoning paths, even before the final response is generated. Based on this analysis, the system reduces the size of the context—producing a second context state—by discarding low-relevance or noisy chunks. It may further refine this by comparing the retained chunks with those initially retrieved, identifying those that are consistently relevant across both retrieval passes. This intersection yields a third, refined context state, representing the most informative and targeted content to guide response generation. This process ensures that only the most useful context is passed to subsequent models, improving the precision, efficiency, and quality of the final contextual response.

In some embodiments, the system may determine the refined context for generating the contextual response by determining a first importance of a first context chunk in the first context state and determining the third context state based on the first importance. For example, the system may determine the refined context for generating the contextual response by evaluating the relevance, or importance, of each context chunk within the initial context set. This process begins with the identification of a first context state, which includes a broad collection of candidate context chunks that might be relevant to the user's input. For each chunk in this set—such as the first context chunk—the system uses a relevance-scoring mechanism, such as a semantic similarity model, retrieval ranker, or lightweight language model, to compute a first importance score. This score reflects how likely the chunk is to support accurate or meaningful generation in response to the user's query. The system repeats this process for other chunks in the context state, assigning importance scores based on features such as lexical overlap with the query, alignment with anticipated answer patterns, or frequency of selection in prior forward passes. Once all importance scores are determined, the system selects the most relevant subset of chunks—those with the highest scores—to construct a third context state, which serves as the refined context. This third context state contains only the most informative and contextually aligned chunks, thereby improving the quality and focus of the eventual response generated by the system.

In some embodiments, the system may determine, using the first model, the refined context for generating the contextual response by determining a first number of parameters in the first model, comparing the first number of parameters to a threshold number of parameters, and selecting the first model based on the first number of parameters corresponding to the threshold number of parameters. For example, the system may determine the refined context for generating the contextual response by strategically selecting a first model based on its size and efficiency, particularly by evaluating the number of parameters in the model. The process begins by identifying the first number of parameters associated with a candidate model, which reflects its complexity, computational demand, and suitability for various tasks. The system then compares this first number of parameters to a predefined threshold, which serves as a boundary for acceptable resource use, such as latency requirements, hardware limitations, or real-time performance constraints. If the number of parameters in the candidate model is at or below the threshold, the system proceeds to select this first model for performing the task of refining the context. The selected model is then used to analyze an initial broad context set, evaluating the relevance of individual chunks and producing a refined context based on semantic similarity, predictive value, or contribution to likely reasoning paths. This approach ensures that the model used for forward context analysis is lightweight enough to operate efficiently, while still being powerful enough to accurately identify the most useful information for guiding final response generation.

In some embodiments, the system may determine, using the first model, the refined context for generating the contextual response by determining a first number of parameters in the first model, comparing the first number of parameters to a second number of parameters in the second model, and selecting the first model based on the first number of parameters being less than the second number of parameters. For example, the system may determine the refined context for generating the contextual response by selecting and using a first model based on its parameter size in comparison to a second model. The process begins by identifying the first number of parameters in the first model, which typically reflects a smaller, more computationally efficient architecture designed for tasks like context filtering or reasoning prediction. The system then identifies the second number of parameters in a larger, more powerful model that is intended for tasks requiring deeper language understanding or high-quality generation. By comparing these two parameter counts, the system verifies that the first model is significantly smaller than the second—i.e., the first number of parameters is less than the second number. Based on this comparison, the system selects the first model for performing forward context analysis, ensuring that it is lightweight enough to execute efficiently in the early stages of processing. The first model is then used to evaluate an initial set of context chunks and determine their relevance to the user input, resulting in a refined context. This refined set can then be passed to the larger, second model, which uses the optimized context to generate a more accurate and context-aware response. This tiered approach balances computational efficiency with output quality by assigning the appropriate model to each stage of processing.

At step 406, process 400 (e.g., using one or more components described above) determines a second context state. For example, the system may reduce a size of the first context state to determine a second context state. The system may reduce the size of the first context state to determine a second context state by applying a filtering or ranking mechanism that evaluates the relevance of each context chunk in relation to the user input or a predicted response. The first context state typically consists of a large, broad collection of information—such as documents, passages, or prior conversation turns—that may contain useful material for generating a response. To streamline processing and improve precision, the system analyzes each chunk using relevance scoring techniques, which may include lexical similarity, semantic embeddings, retrieval ranks, or overlaps with anticipated reasoning paths generated by a lightweight model. The system then assigns an importance score to each chunk and ranks them accordingly. Based on a pre-defined threshold—such as a fixed number of top-scoring chunks or a cumulative relevance score cutoff —the system filters out the least relevant entries, retaining only the most informative ones. The resulting subset of high-quality context chunks forms the second context state, which is smaller, more focused, and optimized for downstream processing, such as input into a more powerful language model for final response generation. This reduction process enhances computational efficiency while improving the relevance and clarity of the eventual output.

In some embodiments, the system may reduce the size of the first context state to determine the second context state by receiving a threshold context state size, determining that the size exceeded the threshold context state size, and determining to reduce the size based on determining that the size exceeded the threshold context state size. For example, the system may reduce the size of the first context state to determine the second context state by using a threshold-based approach to manage context length and ensure processing efficiency. Initially, the system receives or is configured with a threshold context state size, which defines the maximum allowable number of context chunks or total token count that can be effectively processed by subsequent models. After generating the first context state—comprising a broad set of potentially relevant chunks—the system evaluates its size, either in terms of the number of chunks or the combined token length. If it determines that the size of the first context state exceeds the threshold, the system recognizes that keeping the entire set would violate computational or model constraints, such as context length limits in a language model. As a result, the system determines to reduce the size of the first context state by applying filtering, truncation, or ranking techniques to select only the most relevant chunks. This reduction process yields the second context state, a smaller, refined subset that conforms to the threshold and preserves the most useful information for generating an accurate and contextually grounded response.

At step 408, process 400 (e.g., using one or more components described above) compares the first and second context state to determine the third context state. For example, the system may compare an overlap between the first context state and the second context state to determine a third context state. The system may compare the overlap between the first context state and the second context state to determine a third context state by identifying which context chunks are consistently recognized as relevant across both sets. After generating a broad first context state and refining it to a more focused second context state—typically through scoring and filtering—the system examines the relationship between the two. It evaluates the overlap, which may involve identifying identical chunks present in both states or computing similarity scores between chunks in the two sets based on semantic or lexical features. This comparison allows the system to detect which pieces of context not only appeared in the initial retrieval but also survived the reduction process, indicating a higher likelihood of importance and consistency. The third context state is then constructed from this overlap, representing a set of chunks that are validated through both forward analysis (e.g., model-predicted importance) and backward relevance (e.g., query-based retrieval). This dual confirmation helps the system form a context state that balances completeness with precision, optimizing the information passed to the final response generation model for accuracy and relevance.

In some embodiments, the system may compare the overlap between the first context state and the second context state to determine the third context state by determining a relevant context chunk based on the first context state and the second context state and determining the third context state based on the relevant context chunk. For example, the system may compare the overlap between the first context state and the second context state to determine the third context state by identifying context chunks that are present or highly similar in both states, thereby designating them as relevant. This process begins with the system evaluating each chunk in the first context state against those in the second context state to find matches or strong semantic alignments. When a chunk appears in both states, or when it is determined to have high similarity based on features such as token overlap, embedding distance, or retrieval scores, the system identifies it as a relevant context chunk. This chunk's presence in both stages suggests that it is consistently valuable across different filtering criteria—whether driven by the original query or model-based prediction. The system then uses this relevant context chunk as part of the foundation for building the third context state, which is composed of all such verified or validated chunks. This ensures that the final context set used for response generation contains the most meaningful, durable information, increasing both precision and reliability in the system's output.

In some embodiments, the system may compare the overlap between the first context state and the second context state to determine the third context state by determining a similarity between a first context chunk in the first context state and a second context chunk in the second context state, comparing the similarity to a threshold similarity, and determining the third context state based on the similarity exceeding the threshold similarity. For example, the A system may compare the overlap between the first context state and the second context state to determine the third context state by measuring the similarity between individual context chunks from each state and using a threshold-based approach to identify overlaps. Specifically, the system evaluates the similarity between a first context chunk from the first context state and a second context chunk from the second context state using techniques such as cosine similarity between embeddings, token overlap, or semantic distance metrics. It then compares the computed similarity to a predefined threshold similarity value, which represents the minimum degree of alignment required for two chunks to be considered overlapping or related. If the similarity score exceeds the threshold, the system determines that the pair reflects a meaningful contextual match, and the associated chunk is selected as part of the third context state. By repeating this process across the candidate pairs from both context states, the system assembles a third context state composed of the most semantically consistent and jointly relevant chunks. This ensures that the final context used for response generation reflects information validated from both the initial broad retrieval and the refined filtering step, improving the focus and accuracy of the system's output.

In some embodiments, the system may compare the overlap between the first context state and the second context state to determine the third context state by ranking context chunks based on a respective similarities between a first set of context chunks in the first context state and a second set of context chunks in the second context state and determining the third context state based on ranking the context chunks. For example, the system may compare the overlap between the first context state and the second context state to determine the third context state by performing a ranking operation based on the similarities between context chunks across the two states. To begin, the system identifies a first set of context chunks from the first context state and a second set of context chunks from the second context state. It then computes similarity scores between each pair of chunks—typically using semantic similarity measures such as cosine similarity of embeddings, Jaccard similarity, or token-based matching algorithms. These similarity scores reflect how closely aligned each chunk from the first state is with those in the second. Next, the system ranks the context chunks based on these similarity scores, prioritizing those that show the highest levels of alignment across the two states. The third context state is then determined by selecting the top-ranked chunks, which are presumed to be the most contextually relevant due to their strong presence in both the broader initial set and the refined subset. This ranking-based approach ensures that the final context used for response generation is composed of the most semantically consistent and highly validated information, improving the accuracy and relevance of the system's output.

In some embodiments, the system may compare the overlap between the first context state and the second context state to determine the third context state by determining a first output by processing the user input and the first context state in the first model, determining a second output by processing the user input and the second context state in the first model, and comparing the first output and the second output to determine the third context state. For example, the system may compare the overlap between the first context state and the second context state to determine the third context state by evaluating how each context state influences the model's output when combined with the same user input. To do this, the system first processes the user input along with the first context state using a first model, such as a lightweight language model, to generate a first output—which might be a preliminary response, a reasoning trace, or a relevance score distribution. It then repeats the process by inputting the same user input along with the second context state into the same model to generate a second output. These two outputs reflect the model's interpretation of the user's request when supported by different context sets. The system then compares the first and second outputs, analyzing how the presence or absence of certain chunks influenced the responses. This comparison may involve examining overlapping content, answer consistency, or confidence scores. Based on this analysis, the system determines which context chunks are most responsible for stable, high-quality outputs across both states. These validated or commonly influential chunks are then selected to form the third context state, which is refined and optimized for final response generation. This method ensures that the third context state reflects chunks that consistently enhance the model's understanding and are central to generating accurate and contextually aligned answers.

In some embodiments, the system may compare the overlap between the first context state and the second context state to determine the third context state by determining an overlapping context chunk in the first output and the second output and including the overlapping context chunk in the third context state. For example, the system may compare the overlap between the first context state and the second context state to determine the third context state by identifying overlapping context chunks that contribute meaningfully to both outputs generated using the different context states. After processing the user input with the first context state in a model to produce a first output, and separately processing the same user input with the second context state to produce a second output, the system analyzes both outputs to detect references, dependencies, or reasoning steps that involve specific context chunks from each state. If a particular context chunk appears to influence or be referenced in both the first and second outputs, it is recognized as an overlapping context chunk. The system infers that this chunk is central to the model's understanding of the query, regardless of which broader context set it was included in. As a result, the system includes this overlapping chunk in the third context state, which is constructed to capture only the most consistently relevant and reliable pieces of information. This approach ensures that the final context used for response generation is distilled from the most critical shared content, enhancing the clarity, coherence, and accuracy of the system's final output.

In some embodiments, the system may compare the overlap between the first context state and the second context state to determine the third context state by determining a first response based on the first output, wherein the first response comprises human-readable text, determining a second response based on the second output, wherein the second response comprises the human-readable text, and determining a corresponding word in the first response and the second response. For example, the system may compare the overlap between the first context state and the second context state to determine the third context state by analyzing the human-readable responses generated from each. After processing the user input with the first context state, the system generates a first output, which is then decoded or interpreted into a first response comprising human-readable text. Similarly, the system processes the same user input with the second context state to generate a second output, which is also converted into a second response in human-readable form. The system then performs a textual comparison between the two responses to identify corresponding words or phrases that appear in both, indicating shared or consistent information derived from the two different context states. These overlapping words are used as anchors to trace back to the context chunks that likely contributed to them. If certain chunks are responsible for producing the same key terms or ideas in both responses, the system infers that these chunks are especially relevant. Those contributing context chunks are then included in the third context state, which represents a refined and validated selection of context that is most likely to support coherent, consistent, and accurate response generation. This method allows the system to triangulate on high-value context through semantic consistency across multiple retrieval paths.

In some embodiments, the system may compare the overlap between the first context state and the second context state to determine the third context state by sampling first data in the first context state, sampling second data in the second context state, and comparing the first data and the second data. For example, the system may compare the overlap between the first context state and the second context state to determine the third context state by performing a sampling-based comparison of the content within each state. This process begins with the system sampling first data—which could be representative context chunks, excerpts, or token-level features—from the first context state, and separately sampling second data from the second context state. These samples are intended to capture the most salient or statistically significant elements of each state without requiring a full pairwise comparison of all content. The system then compares the first and second data samples using similarity metrics such as lexical overlap, semantic similarity (e.g., embedding distance), or concept alignment to identify areas of meaningful overlap. If specific data points—such as named entities, key phrases, or concept vectors—appear in both samples, the system treats them as indicators of shared relevance. Based on this comparison, the system identifies the context chunks that contributed to the overlapping data and includes those chunks in the third context state. This method enables the system to efficiently focus on the most relevant and commonly reinforced information across two rounds of context selection, ensuring that the final context passed to the response generation model is both compact and contextually robust.

In some embodiments, the system may compare the overlap between the first context state and the second context state to determine the third context state by determining the size of the first context state and determining an importance metric for context chunks based on the size. For example, the system may compare the overlap between the first context state and the second context state to determine the third context state by leveraging the size of the first context state to guide the assignment of importance metrics to individual context chunks. After forming the first context state—a broad collection of potentially relevant chunks—the system calculates its total size, which could be measured in terms of the number of chunks, total tokens, or semantic density. Using this size as a reference, the system then determines an importance metric for each chunk, assigning higher or lower scores based on factors such as how frequently a chunk type appears, its distinctiveness, or its contribution to reducing redundancy within the large set. Chunks that provide novel, non-redundant, and high-value content may be rated as more important in proportion to the overall context size, since larger context states are more likely to contain noise or repetition. The system then compares these importance metrics to those calculated from the second context state and selects the context chunks with the highest aligned importance to form the third context state. This ensures that the final refined set reflects context that stands out not only by relevance but also by proportional significance within the broader context landscape.

In some embodiments, the system may compare the overlap between the first context state and the second context state to determine the third context state by determining the size of the first context state, determining a reduced size of the second context state, and determining an importance metric for context chunks based on a difference in the size and the reduced size. For example, the system may compare the overlap between the first context state and the second context state to determine the third context state by analyzing the difference in size between the two context states and using that difference to guide the calculation of importance metrics for individual context chunks. Initially, the system determines the size of the first context state, which includes a broad collection of candidate chunks, and then determines the reduced size of the second context state, which is a more refined subset selected based on relevance or model-driven filtering. The system calculates the difference between the two sizes, representing the extent of content reduction that occurred during refinement. This size difference is then used to infer how selective the filtering process was and to assign importance metrics to context chunks—favoring those that persisted through the reduction or that bridge the semantic gap between the initial and refined sets. Chunks that were retained despite aggressive downscaling or that strongly align with the highest-ranked entries in both states may be assigned greater importance. Based on these importance metrics, the system identifies the most consistently valuable chunks and aggregates them to form the third context state, which reflects a balanced set of information that is both broadly relevant and refined for precision. This method ensures that the final context used for response generation emphasizes durable, high-signal information that has demonstrated value across different levels of context filtering.

At step 410, process 400 (e.g., using one or more components described above) determines the contextual response. For example, the system may input the user input and the third context state into a second model to determine the contextual response. The system may A system may input the user input and the third context state into a second model to determine the contextual response by first preparing both components in a format compatible with the model's architecture —typically a large language model capable of processing multi-turn or context-rich inputs. The user input, such as a transcribed query or command, is combined with the third context state, which represents a refined set of context chunks that have been selected through prior forward and backward analyses for their high relevance. The system structures the input sequence by either concatenating the user query with the context chunks in a logical order or by encoding the context as auxiliary inputs (e.g., prefix tokens, embedded documents, or memory vectors) depending on the model's conditioning mechanism. Once formatted, this combined input is passed into the second model, which is typically more powerful and context-sensitive than earlier models used in the pipeline. The model processes the information using attention mechanisms that allow it to reason over both the user's intent and the relevant contextual information, ultimately generating a contextual response that is accurate, coherent, and tailored to the specific query. This output is then prepared for delivery to the user interface, completing the process of generating a response grounded in carefully filtered and relevant background knowledge.

In some embodiments, the system may generate for display, on a user interface, the contextual response. For example, the system may generate the contextual response for display on a user interface by first taking the final output produced by the language model—typically a text-based answer or recommendation—and formatting it for clarity and usability. Once the contextual response is generated based on the user input and the third context state, the system performs any necessary post-processing, such as correcting formatting, sanitizing language, or adding appropriate labels or metadata. The system then selects a display method suited to the type of user interface in use—whether it's a text box in a chatbot, a speech synthesis module for voice assistants, or a visual panel in a dashboard. The response is rendered in a readable and structured format, possibly enhanced with styling elements like bolded keywords, hyperlinks, or sectioning to improve user comprehension. If the interface is interactive, the system may also include follow-up options or clarification prompts based on the context. Finally, the response is transmitted to the front-end of the application, where it is displayed to the user in real time, ensuring that the information is both accessible and tailored to the user's original query and intent.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for forward-backward lookup for generating outputs.
2. The method of any one of the preceding embodiments, further comprising: receiving a user input for generating a contextual response; determining, using a first model, a refined context for generating the contextual response by: determining a first context state; reducing a size of the first context state to determine a second context state; comparing an overlap between the first context state and the second context state to determine a third context state; inputting the user input and the third context state into a second model to determine the contextual response; and generating for display, on a user interface, the contextual response.
3. The method of any one of the preceding embodiments, wherein comparing the overlap between the first context state and the second context state to determine the third context state further comprises: determining a relevant context chunk based on the first context state and the second context state; and determining the third context state based on the relevant context chunk.
4. The method of any one of the preceding embodiments, wherein comparing the overlap between the first context state and the second context state to determine the third context state further comprises: determining a similarity between a first context chunk in the first context state and a second context chunk in the second context state; comparing the similarity to a threshold similarity; and determining the third context state based on the similarity exceeding the threshold similarity.
5. The method of any one of the preceding embodiments, wherein comparing the overlap between the first context state and the second context state to determine the third context state further comprises: ranking context chunks based on a respective similarities between a first set of context chunks in the first context state and a second set of context chunks in the second context state; and determining the third context state based on ranking the context chunks.
6. The method of any one of the preceding embodiments, wherein comparing the overlap between the first context state and the second context state to determine the third context state further comprises: determining a first output by processing the user input and the first context state in the first model; determining a second output by processing the user input and the second context state in the first model; and comparing the first output and the second output to determine the third context state.
7. The method of any one of the preceding embodiments, wherein comparing the first output and the second output to determine the third context state further comprises: determining an overlapping context chunk in the first output and the second output; and including the overlapping context chunk in the third context state.
8. The method of any one of the preceding embodiments, wherein comparing the first output and the second output to determine the third context state further comprises: determining a first response based on the first output, wherein the first response comprises human-readable text; determining a second response based on the second output, wherein the second response comprises the human-readable text; and determining a corresponding word in the first response and the second response
9. The method of any one of the preceding embodiments, wherein determining the refined context for generating the contextual response further comprises: determining a first importance of a first context chunk in the first context state; and determining the third context state based on the first importance.
10. The method of any one of the preceding embodiments, wherein determining, using the first model, the refined context for generating the contextual response further comprises: determining a first number of parameters in the first model; comparing the first number of parameters to a threshold number of parameters; and selecting the first model based on the first number of parameters corresponding to the threshold number of parameters.
11. The method of any one of the preceding embodiments, wherein determining, using the first model, the refined context for generating the contextual response further comprises: determining a first number of parameters in the first model; comparing the first number of parameters to a second number of parameters in the second model; and selecting the first model based on the first number of parameters being less than the second number of parameters.
12. The method of any one of the preceding embodiments, wherein reducing the size of the first context state to determine the second context state further comprises: receiving a threshold context state size; determining that the size exceeded the threshold context state size; and determining to reduce the size based on determining that the size exceeded the threshold context state size.
13. The method of any one of the preceding embodiments, wherein comparing the overlap between the first context state and the second context state to determine the third context state further comprises: sampling first data in the first context state; sampling second data in the second context state; and comparing the first data and the second data.
14. The method of any one of the preceding embodiments, wherein comparing the overlap between the first context state and the second context state to determine the third context state further comprises: determining the size of the first context state; and determining an importance metric for context chunks based on the size.
15. The method of any one of the preceding embodiments, wherein comparing the overlap between the first context state and the second context state to determine the third context state further comprises: determining the size of the first context state; determining a reduced size of the second context state; and determining an importance metric for context chunks based on a difference in the size and the reduced size.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for forward-backward lookup for speech signal processing, the system comprising:
one or more processors; and
one or more non-transitory, computer-readable media, comprising instructions that, when executed by the one or more processors, cause operations comprising:
receiving a user input for generating a contextual response by processing speech signals in the user input;
determining, using a first speech signal processing model, a refined context for generating the contextual response based on a forward context analysis by:
determining a first context state, wherein the first context state comprises a first corpus of context chunks;
reducing a size of the first context state to determine a second context state, wherein the second context state comprises a second corpus of context chunks; and
comparing an overlap between the first context state and the second context state to determine a third context state, wherein the third context state comprises a third corpus of context chunks; and
determining the contextual response using a backward context analysis by:
inputting the user input and the third context state into a second speech signal processing model to determine the contextual response; and
generating for display, on a user interface, the contextual response.

2. A method for forward-backward lookup for generating outputs, the method comprising:
receiving a user input for generating a contextual response;
determining, using a first model, a refined context for generating the contextual response by:
determining a first context state;
reducing a size of the first context state to determine a second context state;
comparing an overlap between the first context state and the second context state to determine a third context state;
inputting the user input and the third context state into a second model to determine the contextual response; and
generating for display, on a user interface, the contextual response.

3. The method of claim 2, wherein comparing the overlap between the first context state and the second context state to determine the third context state further comprises:
determining a relevant context chunk based on the first context state and the second context state; and
determining the third context state based on the relevant context chunk.

4. The method of claim 2, wherein comparing the overlap between the first context state and the second context state to determine the third context state further comprises:
determining a similarity between a first context chunk in the first context state and a second context chunk in the second context state;
comparing the similarity to a threshold similarity; and
determining the third context state based on the similarity exceeding the threshold similarity.

5. The method of claim 2, wherein comparing the overlap between the first context state and the second context state to determine the third context state further comprises:
ranking context chunks based on a respective similarities between a first set of context chunks in the first context state and a second set of context chunks in the second context state; and
determining the third context state based on ranking the context chunks.

6. The method of claim 2, wherein comparing the overlap between the first context state and the second context state to determine the third context state further comprises:
determining a first output by processing the user input and the first context state in the first model;
determining a second output by processing the user input and the second context state in the first model; and
comparing the first output and the second output to determine the third context state.

7. The method of claim 6, wherein comparing the first output and the second output to determine the third context state further comprises:
determining an overlapping context chunk in the first output and the second output; and
including the overlapping context chunk in the third context state.

8. The method of claim 6, wherein comparing the first output and the second output to determine the third context state further comprises:
determining a first response based on the first output, wherein the first response comprises human-readable text;
determining a second response based on the second output, wherein the second response comprises the human-readable text; and
determining a corresponding word in the first response and the second response.

9. The method of claim 2, wherein determining the refined context for generating the contextual response further comprises:
determining a first importance of a first context chunk in the first context state; and
determining the third context state based on the first importance.

10. The method of claim 2, wherein determining, using the first model, the refined context for generating the contextual response further comprises:
determining a first number of parameters in the first model;
comparing the first number of parameters to a threshold number of parameters; and
selecting the first model based on the first number of parameters corresponding to the threshold number of parameters.

11. The method of claim 2, wherein determining, using the first model, the refined context for generating the contextual response further comprises:
determining a first number of parameters in the first model;
comparing the first number of parameters to a second number of parameters in the second model; and
selecting the first model based on the first number of parameters being less than the second number of parameters.

12. The method of claim 2, wherein reducing the size of the first context state to determine the second context state further comprises:
receiving a threshold context state size;
determining that the size exceeded the threshold context state size; and
determining to reduce the size based on determining that the size exceeded the threshold context state size.

13. The method of claim 2, wherein comparing the overlap between the first context state and the second context state to determine the third context state further comprises:
sampling first data in the first context state;
sampling second data in the second context state; and
comparing the first data and the second data.

14. The method of claim 2, wherein comparing the overlap between the first context state and the second context state to determine the third context state further comprises:
determining the size of the first context state; and
determining an importance metric for context chunks based on the size.

15. The method of claim 2, wherein comparing the overlap between the first context state and the second context state to determine the third context state further comprises:
determining the size of the first context state;
determining a reduced size of the second context state; and
determining an importance metric for context chunks based on a difference in the size and the reduced size.

16. One or more non-transitory, computer-readable media, comprising instructions that, when executed by one or more processors, cause operations comprising:
receiving a user input for generating a contextual response;
determining, using a first model, a refined context for generating the contextual response by:
determining a first context state;
reducing a size of the first context state to determine a second context state;
comparing an overlap between the first context state and the second context state to determine a third context state; and
inputting the user input and the third context state into a second model to determine the contextual response.

17. The one or more non-transitory, computer-readable media of claim 16, wherein comparing the overlap between the first context state and the second context state to determine the third context state further comprises:
determining a relevant context chunk based on the first context state and the second context state; and
determining the third context state based on the relevant context chunk.

18. The one or more non-transitory, computer-readable media of claim 16, wherein comparing the overlap between the first context state and the second context state to determine the third context state further comprises:
determining a similarity between a first context chunk in the first context state and a second context chunk in the second context state;
comparing the similarity to a threshold similarity; and
determining the third context state based on the similarity exceeding the threshold similarity.

19. The one or more non-transitory, computer-readable media of claim 16, wherein comparing the overlap between the first context state and the second context state to determine the third context state further comprises:
ranking context chunks based on a respective similarities between a first set of context chunks in the first context state and a second set of context chunks in the second context state; and
determining the third context state based on ranking the context chunks.

20. The one or more non-transitory, computer-readable media of claim 16, wherein comparing the overlap between the first context state and the second context state to determine the third context state further comprises:
determining the size of the first context state;
determining a reduced size of the second context state; and
determining an importance metric for context chunks based on a difference in the size and the reduced size.
